(19) United States
(12) Patent Application Publication
(10) Pub. No.: US 2022/0231504 A1
(43) Pub. Date: Jul. 21, 2022

(54) METHOD, DEVICE AND STORAGE MEDIUM FOR TRAINING POWER SYSTEM SCHEDULING MODEL

(71) Applicant: BEIJING BAIDU NETCOM SCIENCE TECHNOLOGY CO., LTD., Beijing (CN)

(72) Inventors: Hongsheng ZENG, Beijing (CN); Bo ZHOU, Beijing (CN); Kejiao LI, Beijing (CN); Fan WANG, Beijing (CN); Yongfeng CHEN, Beijing (CN); Jingzhou HE, Beijing (CN)

(21) Appl. No.: 17/684,131

(22) Filed: Mar. 1, 2022

(30) Foreign Application Priority Data
Jun. 30, 2021 (CN) 202110735962.1

(51) Int. Cl. H02J 3/06; H02J 3/28

(52) U.S. Cl. CPC H02J 3/06; G06Q 50/06; H02J 2203/20; H02J 3/28

(57) ABSTRACT

A method for training a power system scheduling model includes: generating a plurality of first scheduling sub-models based on a first initial scheduling model; acquiring a first matching degree of historical running state information and each of candidate actions, output by each of the plurality of first scheduling sub-models, by inputting the historical running state information into each of the plurality of first scheduling sub-models; generating a second initial scheduling model by correcting the first initial scheduling model based on first matching degrees corresponding to each of the plurality of first scheduling sub-models; and returning to the generating the plurality of first scheduling sub-models based on the second initial scheduling model, until the matching degree output by the second initial scheduling module meets the convergence condition, determining the second initial scheduling model as the power system scheduling model.

### CROSS-REFERENCE TO RELATED APPLICATION

This application is based upon and claims priority to Chinese Patent Application No. 202110735962.1, filed on Jun. 30, 2021, the entire content of which is incorporated herein by reference.

### TECHNICAL FIELD

The disclosure relates to the field of computer technologies, particularly to the field of artificial intelligence (AI) technologies such as natural language processing (NLP), deep learning (DL), and specifically to a method, an apparatus, a device and a storage medium for training a power system scheduling model.

### BACKGROUND

Electric energy is one of important signs of modernization, which relates to people's daily life. A power grid is a backbone force of power distribution, which plays a key economic and social function by providing reliable electric power for industry and consumers. Due to influences of uncertain factors such as burst conditions, natural disasters and human disasters, a power system needs a large number of personnel and experts to perform intervention and maintenance in different burst scenarios in combination with domain knowledge and historical experiences.

Thus, it is an urgent problem to be solved how to improve a degree of automation of scheduling a power system.

### SUMMARY

The disclosure provides a method, an apparatus, a device and a storage medium for training a power system scheduling model.

According to a first aspect of the disclosure, a method for training a power system scheduling model is provided and includes: acquiring a training data set and a first initial scheduling model, the training data set including historical running state information of a power system; generating a plurality of first scheduling sub-models based on the first initial scheduling model, a network structure of each of the plurality of first scheduling sub-models being the same as a network structure of the first initial scheduling model; acquiring a first matching degree of the historical running state information and each of candidate actions, output by each of the plurality of first scheduling sub-models, by inputting the historical running state information into each of the plurality of first scheduling sub-models; generating a second initial scheduling model by correcting the first initial scheduling model based on first matching degrees corresponding to each of the plurality of first scheduling sub-models; and returning to the generating the plurality of first scheduling sub-models based on the second initial scheduling model, until a difference between a second matching degree of the historical running state information and each of the candidate actions, determined by the second initial scheduling model, and a third matching degree of the historical running state information and each of the candidate actions, determined by the first initial scheduling model, is within a preset range, determining the second initial scheduling model as the power system scheduling model.

According to another aspect of the disclosure, a computer device is provided and includes: at least one processor; and a memory communicatively connected to the at least one processor; in which the memory is configured to store instructions executable by the at least one processor, and when the instructions are performed by the at least one processor, the at least one processor is caused to perform the method as described above.

According to another aspect of the disclosure, a non-transitory computer-readable storage medium stored with computer instructions is provided, in which the computer instructions are configured to cause a computer to perform the method as described above.

It should be understood that, the content described in this section is not intended to indicate key or important features of embodiments of the disclosure, nor intended to limit the scope of the disclosure. Other features of the disclosure will be easy to be understood through the following specification.

### BRIEF DESCRIPTION OF THE DRAWINGS

The drawings are intended to better understand the solution and do not constitute a limitation to the disclosure, in which:

FIG. 1 is a flowchart illustrating a method for training a power system scheduling model according to some embodiments of the disclosure.

FIG. 2 is a flowchart illustrating another method for training a power system scheduling model according to some embodiments of the disclosure.

FIG. 3 is a flowchart illustrating another method for training a power system scheduling model according to some embodiments of the disclosure.

FIG. 4 is a flowchart illustrating another method for training a power system scheduling model according to some embodiments of the disclosure.

FIG. 5 is a diagram illustrating determining an execution action by a model corresponding to a power system according to some embodiments of the disclosure.

FIG. 6 is a flowchart illustrating another method for training a power system scheduling model according to some embodiments of the disclosure.

FIG. 7 is a diagram illustrating input and output of a first initial scheduling model according to some embodiments of the disclosure.

FIG. 8 is a flowchart illustrating another method for training a power system scheduling model according to some embodiments of the disclosure.

FIG. 9 is a diagram illustrating a training process of a power system scheduling model according to some embodiments of the disclosure.

FIG. 10 is a block diagram illustrating an apparatus for training a power system scheduling model according to some embodiments of the disclosure.

FIG. 11 is a block diagram illustrating a computer device configured to implement a method for training a power system scheduling model according to some embodiments of the disclosure.

### DETAILED DESCRIPTION

Embodiments of the disclosure are described as below with reference to the drawings, which include various details of embodiments of the disclosure to facilitate understanding, and should be considered as merely exemplary. Therefore, those skilled in the art should realize that various changes and modifications may be made on embodiments described herein without departing from the scope and spirit of the disclosure. Similarly, for clarity and conciseness, descriptions of well-known functions and structures are omitted in the following descriptions.

A method and an apparatus for training a power system scheduling model, a computer device and a storage medium in embodiments of the disclosure are described with reference to the drawings.

Artificial Intelligence (AI) is a discipline that studies and allows computers to simulate certain thinking processes and intelligent behaviors (such as learning, reasoning, thinking and planning) of human, which has both hardware-level technologies and software-level technologies. AI hardware technology generally includes technologies such as sensors, dedicated AI chips, cloud computing, distributed storage, and big data processing. AI software technology generally includes computer vision technology, speech recognition technology, natural language processing technology (NLP), deep learning (DL), big data processing technology, knowledge map technology and other aspects.

Natural Language Processing (NLP) is an important direction in the fields of computer science and artificial intelligence. The research content of NLP includes but is not limited to: text classification, information extraction, automatic abstract, intelligent question answering, topic recommendation, machine translation, subject term recognition, knowledge base construction, deep text representation, named entity recognition, text generation, text analysis (morphology, syntax, grammar, etc.), voice recognition and synthesis.

Deep learning (DL) is a new research direction in the field of machine learning. DL learns inherent law and representation hierarchy of sample data, and information acquired in the learning process is of great help in interpretation of data such as words, images and sound. Its final goal is that the machine may have analytic learning ability like humans, which may recognize data such as words, images, sound, etc.

Computer vision is a science that studies how to make a machine “look”, which refers to performing machine vision such as recognition, tracking and measurement on a target by a camera and a computer instead of human eyes, and further performing graphics processing, so that it may be processed by a computer into an image more suitable for human eyes to observe or transmitted to an instrument for detection.

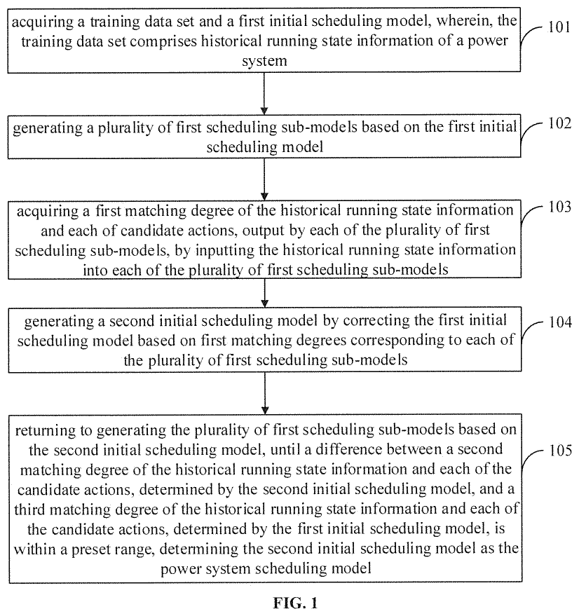

FIG. 1 is a flowchart illustrating a method for training a power system scheduling model according to some embodiments of the disclosure.

As illustrated in FIG. 1, the method for training the power system scheduling model includes 101-105.

At 101, a training data set and a first initial scheduling model are acquired, in which the training data set includes historical running state information of a power system.

In the disclosure, the historical running state information of the power system may be acquired, thereby acquiring the training data set. The historical running state information may include running state information at a moment, running state information within a time period, running state information within a plurality of time periods or the like.

The running state information in the disclosure may include: active power, reactive power and voltage of a power plant; active power, reactive power and voltage of a load; active power, reactive power, voltage and current of a source of a power cord and an end of a power cord; limiting current; a topology structure of a substation; a bus switch state; time information, etc. The time information may include information such as month, week, day, hour, etc.

When the training data set is acquired, an initial scheduling model may be acquired, which may be referred to as the first initial scheduling model for ease of distinction. The first initial scheduling model may be the initial network model or may be acquired by pre-training the initial network model.

At 102, a plurality of first scheduling sub-models are generated based on the first initial scheduling model.

In the disclosure, a plurality of sub-models are generated based on the first initial scheduling model, which may be referred to as the plurality of first scheduling sub-models for ease of distinction. A network structure of each of the plurality of first scheduling sub-models is the same as a network structure of the first initial scheduling model.

When the plurality of first scheduling sub-models are generated, different Gaussian noise disturbances may be performed on parameters of the first initial scheduling model, for example, the plurality of first scheduling sub-models may be generated by adding noises on parameters of the first initial scheduling model.

At 103, a first matching degree of the historical running state information and each of candidate actions, output by each of the plurality of first scheduling sub-models, is acquired, by inputting the historical running state information into each of the plurality of first scheduling sub-models.

In the disclosure, the historical running state information may be input into each of the plurality of first scheduling sub-models. Each of the plurality of first scheduling sub-models is configured to process the historical running state information, to acquire a matching degree of the historical running state information and each of the candidate actions, which is referred to as the first matching degree for convenience of distinction.

There may be a plurality of candidate actions, and the actions may be understood as actions taken by scheduling the power system. For example, the actions may include power regulation of a power plant, switching on a bus switch and change of a topology of a substation.

The first matching degree in the disclosure may be configured to measure a running stability degree when performing each of the candidate actions under the historical running state information of the power system, and also may be understood as a score of each of the candidate actions predicted under the historical running state information of the power system. The higher first matching degree indicates the better running stability degree of the power system when performing the corresponding action under the historical running state information.

For example, there are 200 first scheduling sub-models and 100 candidate actions, the running state information at a moment may be input into each of the first scheduling sub-models, and each of the first scheduling sub-models may output the first matching degree of the historical running state information and each of the candidate actions.

It may be understood that, when the historical running state information is running state information within a time period, the first matching degree of the historical running state information and each of the candidate actions includes a first matching degree of the running state information at each moment extracted within the time period and each of the candidate actions.

In order to facilitate the processing of the first scheduling sub-model, in the disclosure, the historical running state information may be normalized, for example, the time information may be discretized and embedded, etc.

At 104, a second initial scheduling model is generated by correcting the first initial scheduling model based on first matching degrees corresponding to each of the plurality of first scheduling sub-models.

After the matching degree of the historical running state information and each of the candidate actions, output by each of the first scheduling sub-models, is acquired, the first initial scheduling model is corrected based on first matching degrees respectively corresponding to the plurality of first scheduling sub-models to generate the second initial scheduling model.

When correction is performed, the action performed when the power system is under the historical running state information may be determined based on the output of each of the first scheduling sub-models, a parameter adjustment value may be determined based on the first matching degree of the action and the historical running state information, and the first initial scheduling model parameter may be corrected based on the parameter adjustment value, to generate the second initial scheduling model.

At 105, it returns to execute an operation of generating the plurality of first scheduling sub-models based on the second initial scheduling model, until a difference between a second matching degree of the historical running state information and each of the candidate actions, determined by the second initial scheduling model, and a third matching degree of the historical running state information and each of the candidate actions, determined by the first initial scheduling model, is within a preset range, the second initial scheduling model is determined as the power system scheduling model.

After the second initial scheduling model is acquired, a plurality of second scheduling sub-models are generated based on the second initial scheduling model, in which a network structure of each of the plurality of second scheduling sub-models is the same as a network structure of the second initial scheduling model. Then, the historical running state information is input into each of the plurality of second scheduling sub-models, to acquire a matching degree of the historical running state information and each of the candidate actions, and the second initial scheduling model is corrected based on matching degrees respectively corresponding to the plurality of second scheduling sub-models, until the second initial scheduling model is converged to generate the power system scheduling model.

The convergence may be that the difference between the second matching degree of the historical running state information and each of the candidate actions, determined by the second initial scheduling model, and the third matching degree of the historical running state information and each of the candidate actions, determined by the first initial scheduling model, is within the preset range. That is, the difference between the matching degree of the historical running state information and each candidate action determined by the current initial scheduling model and the matching degree of the historical running state information and each candidate action determined by the previous initial scheduling model is within the preset range.

The difference between the second matching degree and the third matching degree, may be a sum of differences between the second matching degree and the third matching degree corresponding to each candidate action or may be a difference between a sum of the second matching degrees of all candidate actions and a sum of the third matching degrees of all candidate actions.

In order to enhance a training speed of a model, the first initial scheduling model may be trained in parallel in the disclosure. For example, the first initial scheduling model includes 5 million parameters, and evolutionary learning may be performed on the first initial scheduling model including 5 million parameters on thousands of central processing units (CPU) at the same time.

According to some embodiments of the disclosure, the plurality of first scheduling sub-models with the same network structure as the first initial scheduling model are generated based on the first initial scheduling model, the historical running state information is input into each of the plurality of first scheduling sub-models to acquire the first matching degree of the historical running state information and each of candidate actions, the first initial scheduling model is corrected to generate the second initial scheduling model based on the first matching degrees respectively corresponding to the plurality of first scheduling sub-models, and it returns to execute the operation of generating the plurality of first scheduling sub-models based on the second initial scheduling model, until the matching degree output by the second initial scheduling module meets the convergence condition, so as to acquire the power system scheduling module. Thus, large-scale evolutionary learning is performed on the first initial scheduling model, to acquire the power system scheduling model, and the power system scheduling model is employed to schedule the power system, thereby enhancing a degree of automation of scheduling the power system.

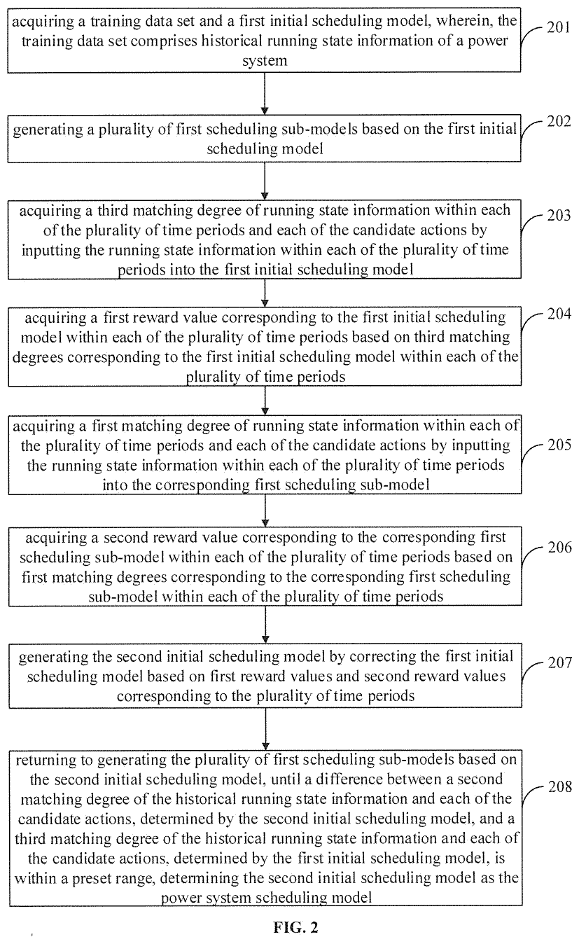

In order to enhance the accuracy of the model, in some embodiments of the disclosure, the historical running state information may include running state information within a plurality of time periods, the running state information within each of the plurality of time periods may interact with the corresponding first scheduling sub-model, and the model training may be performed based on the interaction result. FIG. 2 is a flowchart illustrating another method for training a power system scheduling model according to some embodiments of the disclosure.

As illustrated in FIG. 2, the method for training the power system scheduling model includes 201-208.

At 201, a training data set and a first initial scheduling model are acquired, in which the training data set includes historical running state information of a power system.

At 202, a plurality of first scheduling sub-models are generated based on the first initial scheduling model.

In the disclosure, 201-202 are similar with 101-102, which are not repeated herein.

At 203, a third matching degree of running state information within each of the plurality of time periods and each of the candidate actions is acquired by inputting the running state information within each of the plurality of time periods into the corresponding first initial scheduling model.

In the disclosure, the historical running state information may include running state information within a plurality of time periods, for example, running state information of the power system on the 1st day of a month, running state information of the power system on the 2nd day, running state information of the power system on the 3rd day, etc.

In the disclosure, the running state information within each of the plurality of time periods may be input into the first initial scheduling model, to acquire the third matching degree of the running state information within each of the plurality of time periods and each of the candidate actions. The third matching degree of the running state information within each of the plurality of time periods and each of the candidate actions, may be the third matching degree of the running state information at a moment within the time period and each of the candidate actions, may be the third matching degree of the running state information at each of the plurality of moments and each of the candidate actions or the like.

At 204, a first reward value corresponding to the first initial scheduling model within each of the plurality of time periods is acquired based on third matching degrees corresponding to the first initial scheduling model within each of the plurality of time periods.

In the disclosure, the maximum third matching degree in third matching degrees corresponding to the first initial scheduling model within each of the plurality of time periods may be taken as the reward value corresponding to the first initial scheduling model within each of the plurality of time periods, which, for ease of distinction, may be referred to as the first reward value. Or, a sum of the third matching degrees of the running state information within each of the plurality of time periods and each of the candidate actions, output by the first initial scheduling model may be taken as the first reward value corresponding to the first initial scheduling model within each of the plurality of time periods.

At 205, a first matching degree of the running state information within each of the plurality of time periods and each of the candidate actions is acquired by inputting the running state information within each of the plurality of time periods into the corresponding first scheduling sub-model.

In the disclosure, the running state information within each of the plurality of time periods may be input into the corresponding first scheduling sub-model, to acquire the first matching degree of the running state information within each of the plurality of time periods and each of the candidate actions, output by the corresponding first scheduling sub-model.

That is, the time periods the running state information inputted into the first scheduling sub-models belongs to are different.

In the disclosure, the corresponding relationship between the time period and the first scheduling sub-model may be set as required or determined randomly. For example, the running state information within the plurality of time periods may be respectively input into the plurality of first scheduling sub-models with number from small to large based on the specified sequence of the time periods.

For another example, the running state information within a time period is randomly selected, and input to one first scheduling sub-model.

At 206, a second reward value corresponding to the corresponding first scheduling sub-model within each of the plurality of time periods is acquired based on first matching degrees corresponding to the corresponding first scheduling sub-model within each of the plurality of time periods.

In the disclosure, 206 is similar with 204, which is not repeated herein.

At 207, the second initial scheduling model is generated by correcting the first initial scheduling model based on first reward values and second reward values corresponding to the plurality of time periods.

For each time period, the second reward value corresponding to the first scheduling sub-model may subtract the first reward value corresponding to the first initial scheduling model to acquire a normalized reward value of the first scheduling sub-model within each time period. That is, the difference between the reward value corresponding to the first scheduling sub-model within the same time period and the reward value corresponding to the first initial scheduling model may be taken as the reward value normalized by the first scheduling sub-model.

When the normalized reward value corresponding to each first scheduling sub-model is acquired, the normalized reward values respectively corresponding to the plurality of first scheduling sub-models may be integrated, for example, added. Based on the integrated reward value, an adjustment value of a network parameter is determined, and configured to adjust the parameter of the first initial scheduling model, to generate the second initial scheduling model.

In the disclosure, an evolutionary direction of network parameters of the first initial network model is determined based on the normalized reward values corresponding to the plurality of first scheduling sub-models, thereby correcting the first initial scheduling model to generate the second initial scheduling model.

At 208, it returns to execute an operation of generating the plurality of first scheduling sub-models based on the second initial scheduling model, until a difference between a second matching degree of the historical running state information and each of the candidate actions, determined by the second initial scheduling model, and a third matching degree of the historical running state information and each of the candidate actions, determined by the first initial scheduling model, is within a preset range, the second initial scheduling model is determined as the power system scheduling model.

In the disclosure, 208 is similar with 105, which is not repeated herein.

According to some embodiments of the disclosure, the historical running state information may include the running state information within the plurality of time periods. The running state information within each of the plurality of time periods may be input into the first initial scheduling model to acquire the third matching degree of the running state information within each of the plurality of time periods and each of the candidate actions. The first reward value corresponding to the first initial scheduling model within each of the plurality of time periods is determined based on third matching degrees corresponding to the first initial scheduling model within each of the plurality of time periods. The running state information within each of the plurality of time periods is input into the corresponding first initial scheduling model, to acquire the first matching degree of the running state information within each of the plurality of time periods and each of the candidate actions. The second reward value corresponding to the first scheduling sub-model within each of the plurality of time periods is acquired based on first matching degrees corresponding to the first scheduling sub-model within each of the plurality of time periods. The first initial scheduling model is corrected based on the corresponding first reward values and the second reward values within the plurality of time periods to generate the second initial scheduling model to continue training, and finally generate the power system scheduling model. Thus, each first scheduling sub-model interacts with the power system within the different time period, thereby training the first initial scheduling model, which enhances the accuracy of the model.

In some embodiments of the disclosure, the first reward value may be further acquired in the manner as illustrated in FIG. 3. FIG. 3 is a flowchart illustrating another method for training a power system scheduling model according to some embodiments of the disclosure.

As illustrated in FIG. 3, acquiring the first reward value corresponding to the first initial scheduling model within each of the plurality of time periods, includes 301-304.

At 301, running state information at a plurality of moments is extracted from the running state information within each of the plurality of time periods.

In the disclosure, the running state information at the plurality of moments may be extracted from the running state information within each of the plurality of time periods. For example, the running state information at 1000 moments may be extracted from the running state information of the power system on a day.

At 302, a third matching degree of running state information at each of the plurality of moments and each of the candidate actions is acquired by inputting the running state information at each of the plurality of moments into the first initial scheduling model.

When the running state information at the plurality of moments is acquired, the running state information at each of the plurality of moments may be input into the first initial scheduling model, to acquire the third matching degree of the running state information at each of the plurality of moments and each of the candidate actions. That is, the running state information at each of the plurality of moments is input into the first initial scheduling model, to acquire a score of each of the candidate actions under the running state information at each of the plurality of moments.

At 303, a first target action is extracted from the candidate actions based on third matching degrees.

For the running state information at each of the plurality of moments, the first target action may be extracted from the candidate actions based on the third matching degree of the running state information at each of the plurality of moments and each of the candidate actions. Thus, the corresponding first target action may be acquired based on the running state information at each of the plurality of moments.

In the disclosure, a candidate action with the highest third matching degree may be extracted from the candidate actions as the first target action.

At 304, the first reward value is determined based on third matching degrees of the running state information at the plurality of moments and the first target action.

After the first target action is extracted based on the third matching degree of the running state information at each of the plurality of moments and each of the candidate actions, the first reward value is determined based on the first matching degrees of the running state information at the plurality of moments and the first target action.

For example, a sum of all first matching degrees corresponding to the first target action may be taken as the first reward value. That is, for the running state information at each of the plurality of moments within a time period, the action performed by the power system may be determined based on the output of the first initial scheduling model, and the determined third matching degrees within the time period, corresponding to the action, may be accumulated as the first reward value.

Alternatively, for the running state information at each of the plurality of moments within a time period, the model corresponding to the power system may be controlled to run based on the first target action acquired, a score of the first target action is determined based on the running state, and a sum of scores of the first target action at all moments within the time period is determined as the first reward value.

It may be understood that, when the second reward is acquired, it may be acquired in a manner similar to FIG. 3, which is not repeated herein.

According to some embodiments of the disclosure, when the first reward value corresponding to the first initial scheduling model within each time period is acquired, running state information at the plurality of moments may be extracted from the running state information within each time period. The running state information at each of the plurality of moments may be input into the first initial scheduling model, to acquire the third matching degree of the running state information at each of the plurality of moments and each of the candidate actions, the first target action is extracted from the candidate actions, and the first reward value is determined based on the third matching degrees of the running state information at the plurality of moments and the first target action. Thus, the first reward value may be determined based on an accumulation of matching degrees corresponding to the first target action at the plurality of moments within a time period.

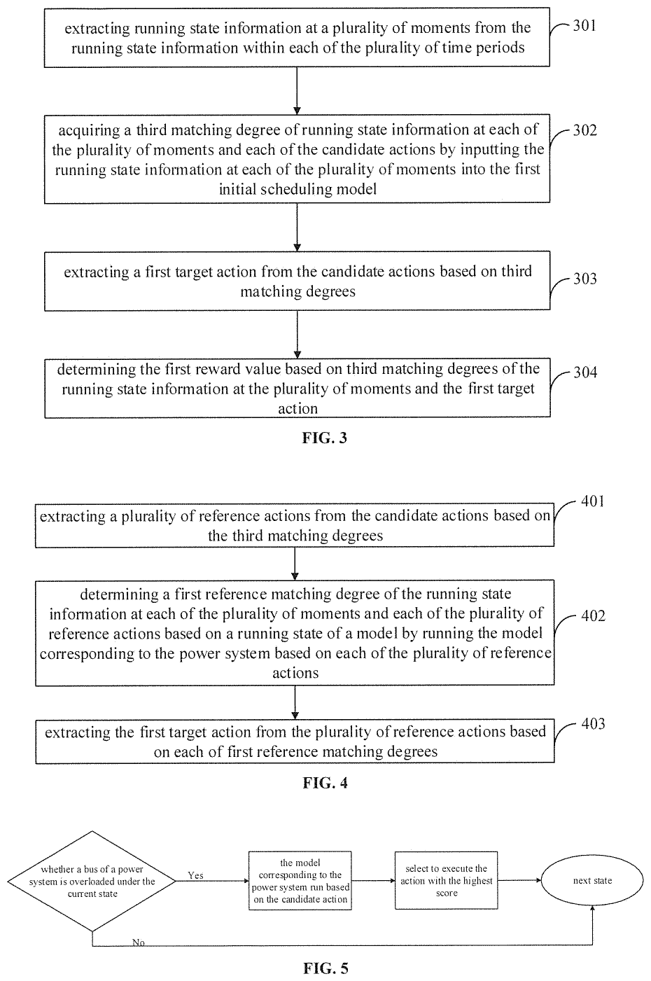

As the above embodiments described, the first target action may be directly extracted based on the third matching degrees. In some embodiments of the disclosure, in combination with the matching degree determined by the running state of the model corresponding to the power system, the first target action is extracted. FIG. 4 is a flowchart illustrating another method for training a power system scheduling model according to some embodiments of the disclosure.

As illustrated in FIG. 4, extracting the first target action from the candidate actions based on each of third matching degrees, includes 401-403.

At 401, a plurality of reference actions are extracted from the candidate actions based on the third matching degrees.

In the disclosure, for the running state information at each moment, actions may be extracted from the candidate actions based on the third matching degree of the running state information at each moment and each of the candidate actions, which are referred to as the reference actions.

At 402, a first reference matching degree of the running state information at each of the plurality of moments and each of the plurality of reference actions is determined based on a running state of a model by running the model corresponding to the power system based on each of the plurality of reference actions.

In the disclosure, the running state information at each moment may be input into the model corresponding to the power system. The model is controlled to run based on each reference action, to determine the matching degree of the running state information at each moment and each reference action based on the running state at each moment. It is referred to as the first matching degree for ease of distinction. The model corresponding to the power system may be a power system simulation model pre-constructed based on expert knowledge.

For ease of understanding, the running state information at a certain moment may be regarded as a scene, and for each running scene, the model corresponding to the power system may be controlled to run based on each reference action. Thus, the first reference matching degree of each scene and each reference action may be determined based on the running state of the model.

In practical applications, an execution action may also be selected based on the model corresponding to the power system. As illustrated in FIG. 5, it is determined whether there is an overload in a bus of a power system. When there is the overload in the bus of the power system, the model corresponding to the power system may be controlled to run based on each candidate action, and the action with the highest score (that is, a matching degree) may be selected to execute based on the running result of the model, then a next state enters. When there is no overload in the bus of the power system, the next state enters directly without taking action.

At 403, the first target action is extracted from the plurality of reference actions based on each of first reference matching degrees.

After the first reference matching degree of the running state information at each moment and each reference action is determined, the action with the highest first reference matching degree may be extracted from the plurality of reference actions as the first target action.

According to some embodiments of the disclosure, when the first target action is extracted, the reference actions may be extracted from the candidate actions based on the third matching degrees output based on the first initial scheduling model, and the first target action is extracted from the reference actions based on the model corresponding to the power system. Thus, the first target action corresponding to the running state information at each moment is determined based on the first initial scheduling model and the model corresponding to the power system, thereby enhancing the accuracy of determining the first target action.

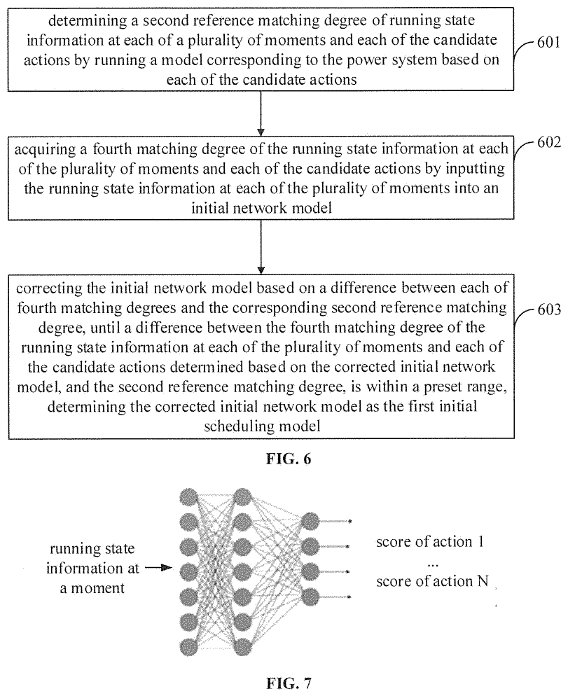

In some embodiments of the disclosure, the first initial scheduling model may be trained based on the method as illustrated in FIG. 6. FIG. 6 is a flowchart illustrating another method for training a power system scheduling model according to some embodiments of the disclosure.

As illustrated in FIG. 6, before the training data set and the first initial scheduling model are acquired, the method further includes 601-603.

At 601, a second reference matching degree of running state information at each of a plurality of moments and each of the candidate actions is determined by running a model corresponding to the power system based on each of the candidate actions.

In the disclosure, the running state at the plurality of moments may be acquired in advance as a training data set. When the running state information at the plurality of moments is acquired, the model corresponding to the power system is controlled to run based on each of the candidate actions, to determine the second reference matching degree of the running state information at each of the plurality of moments and each of the candidate actions based on the running state of the model.

At 602, a fourth matching degree of the running state information at each of the plurality of moments and each of the candidate actions is acquired by inputting the running state information at each of the plurality of moments into an initial network model.

In the disclosure, the running state information at each of the plurality of moments may be input into the initial network model, and the initial network model is employed to process the running state information at each of the plurality of moments, to acquire the fourth matching degree of the running state information at each of the plurality of moments and each of the candidate actions. That is, a score of each of the candidate actions under the running state information at each of the plurality of moments may be acquired.

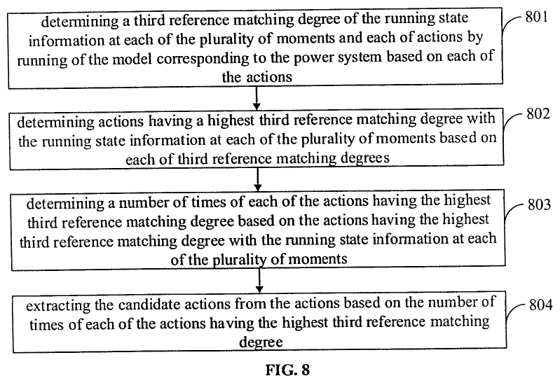

Assuming that the number of candidate actions is N, as illustrated in FIG. 7, the running state information at a moment is input into a model, and the model may output a score of an action 1 to a score of an action N, and the score herein may be configured to measure the matching degree of the running state information at the moment and the action.

At 603, the initial network model is corrected based on a difference between each of fourth matching degrees and the corresponding second reference matching degree, until a difference between the fourth matching degree of the running state information at each of the plurality of moments and each of the candidate actions determined based on the corrected initial network model, and the second reference matching degree, is within a preset range, the corrected initial network model is determined as the first initial scheduling model.

In the disclosure, based on the difference between each of the fourth matching degrees and the corresponding second reference matching degree under the running state information at each moment, the initial network model is corrected, and the corrected initial network model is employed to continue training until the difference between, the fourth matching degree of the running state information at each moment and each candidate action determined based on the corrected initial network model, and the second reference matching degree, is within the preset range, the corrected initial network model is determined as the first initial scheduling model.

The difference between the fourth matching degree of the running state information at each moment and each candidate action and the second reference matching degree is within the preset range, which may be that the difference between the fourth matching degree and the second reference matching degree corresponding to each candidate action is within the preset range, or may be that the difference between the sum of the fourth matching degrees corresponding to all candidate actions and the sum of the second reference matching degrees corresponding to all candidate actions is within the preset range.

In the disclosure, the first initial scheduling model may be trained by deep learning.

According to some embodiments of the disclosure, before the training data set and the first initial scheduling model are acquired, the model corresponding to the power system may be controlled to run based on each candidate action to determine the second reference matching degree of the running state information at each moment and each candidate action, and the running state information at each moment is input into the initial network model to acquire the fourth matching degree of the running state information at each moment and each candidate action. The initial network model is trained based on the difference between the fourth matching degree corresponding to each candidate action under the running state information at each moment and the reference matching degree, to generate the first initial scheduling model. Thus, based on the reference matching degree acquired by a simulation model constructed using expert knowledge, the trained first initial scheduling model combines expert knowledge, and training is continued on the basis of the trained first initial scheduling model to acquire the power system scheduling model, which not only improves the training speed of the power system scheduling model, but also enhances the accuracy of the model.

In practical applications, since the topology of the general power grid is relatively complex, the number of schedulable actions of the power system is extremely large. In some embodiments of the disclosure, in the process of training the initial network model to acquire the first initial scheduling model, before the second reference matching degree of the running state information at each moment and each candidate action is determined, an action with a higher execution frequency may be screened out from a large number of actions as a candidate action. FIG. 8 is a flowchart illustrating another method for training a power system scheduling model according to some embodiments of the disclosure.

As illustrated in FIG. 8, before a second reference matching degree of the running state information at each of the plurality of moments and each of the candidate actions is determined, the method further includes 801-804.

At 801, a third reference matching degree of the running state information at each of the plurality of moments and each of actions is determined by running of the model corresponding to the power system based on each of the actions.

In the disclosure, 801 is similar with 601, which is not repeated herein.

At 802, actions having a highest third reference matching degree with the running state information at each of the plurality of moments are determined based on each of third reference matching degrees.

In the disclosure, the action having the highest third reference matching degree with the running state information at each moment may be determined based on the third reference matching degree of the running state information at each moment and each action.

At 803, a number of times of each of the actions having the highest third reference matching degree is determined based on the actions having the highest third reference matching degree with the running state information at each of the plurality of moments.

When the actions having the highest third reference matching degree with the running state information at each of the plurality of moments are determined, a number of times of each of the actions having the highest third reference matching degree may be determined based on the actions having the highest third reference matching degree with the running state information at each of the plurality of moments.

When the running state information at a moment is regarded as a scene, a number of times of each of the actions having the highest third reference matching degree may be determined based on the actions having the highest third reference matching degree determined in each scene.

At 804, the candidate actions are extracted from the actions based on the number of times of each of the actions having the highest third reference matching degree.

In the disclosure, the action having the highest third reference matching degree, which has the number of times greater than a threshold, may be taken as the candidate action.

According to some embodiments of the disclosure, before the second reference matching degree of the running state information at each moment and each candidate action is determined, the model corresponding to the power system may be controlled to run based on each action, to determine the third reference matching degree of the running state information at each moment and each action, and the candidate actions are screened out from each action based on the third reference matching degree corresponding to each action under the running state information at each moment. Thus, by a simulation model constructed by expert knowledge, the action with a higher number of execution times may be screened out from a large number of actions as the candidate action.

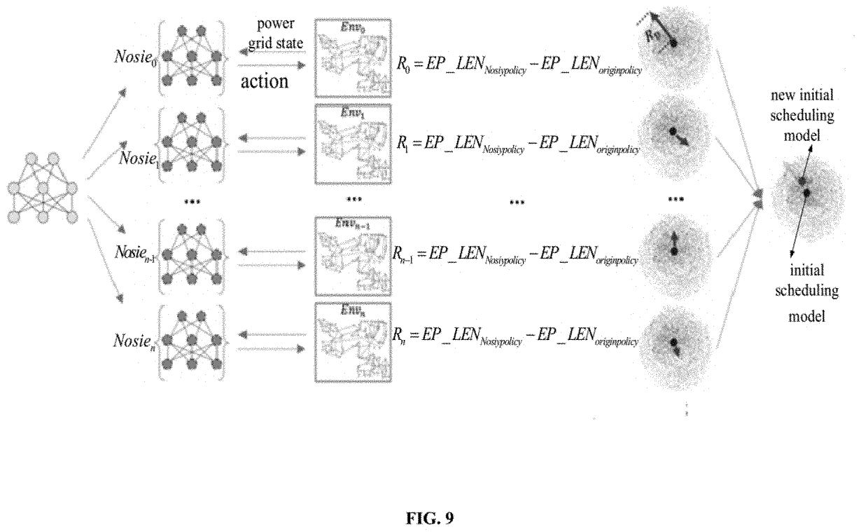

FIG. 9 is a diagram illustrating a training process of a power system scheduling model according to some embodiments of the disclosure.

As illustrated in FIG. 9, noise disturbance may be performed on one neural network model to acquire n+1 sub-models with noise, such as Nosie₀, Nosie₁, . . . , Nosieₙ₋₁, Nosieₙ, and acquired running state information Env₀, Env₁, . . . , Envₙ₋₁, Envₙ within n+1 time periods is respectively input into the sub-models with noise correspondingly, in which each sub-model may determine the action and provide it to the power system.

For each sub-model, the running state information within the corresponding time period is input into the sub-model, to acquire a normalized reward value corresponding to the sub-model. For example, R₀=EP_LEN_{Nosiypolicy}−EP_LEN_{originpolicy} is a normalized reward value corresponding to the sub-model Nosie₀, where, EP_LEN_{Nosiypolicy} represents a first reward value corresponding to the sub-model Nosie₀, and EP_LEN_{originpolicy} represents a second reward value corresponding to an initial scheduling model; Rₜ=EP_LEN_{Nosiypolicy}−EP_LEN_{originpolicy} is a normalized reward value corresponding to the sub-model Nosie₁, where, EP_LEN_{Nosiypolicy} represents a first reward value corresponding to the sub-model Nosie₁, and EP_LEN_{originpolicy} represents a second reward value corresponding to the initial scheduling model. The normalized reward values corresponding to the remaining sub-models are similar, which are not repeated herein.

After the normalized reward values respectively corresponding to n+1 sub-models are acquired, a new initial scheduling model may be generated based on n+1 normalized reward values.

In some embodiments of the disclosure, after the power system scheduling model is acquired, the power system scheduling model may be configured to schedule the power system.

In the disclosure, the current running state information of the power system may be acquired, and the current running state information is input into the power system scheduling model to acquire a matching degree between the current running state information and each candidate action, output by the power system scheduling model.

After the matching degree between the current running state information and each candidate action is acquired, a second target action may be extracted from the candidate actions based on the matching degree between the current running state information and each candidate action. For example, a candidate action with the highest matching degree may be directly selected as the second target action, or a plurality of actions are selected from the candidate actions, and the model corresponding to the power system is controlled to run based on each selected action, to determine the matching degree between each selected action and the current running state information, and the action with the highest matching degree is selected as the second target action. After the second target action is determined, the power system may be scheduled based on the second target action.

For example, there are 100 candidate actions, and 20 actions with the higher matching degree may be extracted based on the matching degree output by the power system scheduling model. One action with the highest matching degree with the current running state information is extracted based on the matching degree acquired by the model corresponding to the power system, to schedule the power system.

According to some embodiments of the disclosure, after the second initial scheduling model is determined as the power system scheduling model, the current running state information of the power system may be input into the power system scheduling model to acquire the matching degree between the current running state information and each candidate action, and the action for scheduling the power system is determined based on the acquired matching degree corresponding to each candidate action. Thus, the power system scheduling model is configured to determine the action for scheduling the power system under the current running state information, which enhances a degree of automation of scheduling the power system.

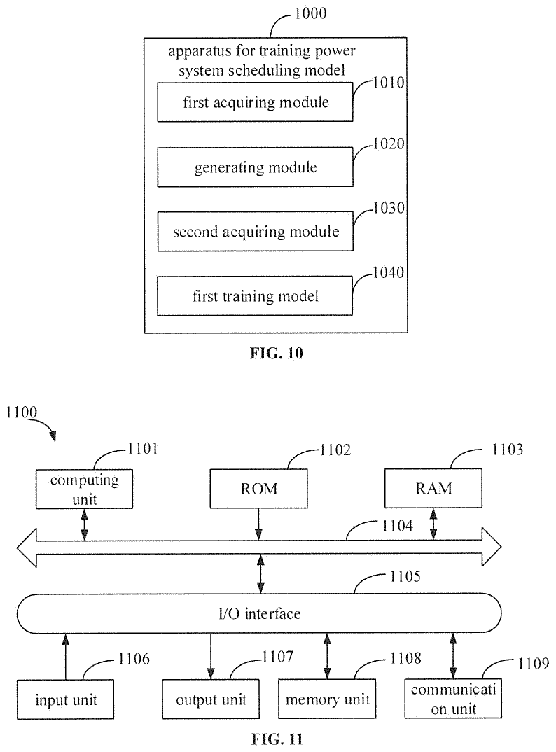

In order to achieve the above embodiments, the embodiments of the disclosure further provide an apparatus for training a power system scheduling model. FIG. 10 is a block diagram illustrating an apparatus for training a power system scheduling model according to some embodiments of the disclosure.

As illustrated in FIG. 10, the apparatus 1000 for training the power system scheduling model includes a first acquiring module 1010, a generating module 1020, a second acquiring module 1030 and a first training model 1040.

The first acquiring module 1010 is configured to acquire a training data set and a first initial scheduling model, in which, the training data set include historical running state information of a power system.

The generating module 1020 is configured to generate a plurality of first scheduling sub-models based on the first initial scheduling model, in which, a network structure of each of the plurality of first scheduling sub-models is the same as a network structure of the first initial scheduling model.

The second acquiring module 1030 is configured to acquire a first matching degree of the historical running state information and each of candidate actions, output by each of the plurality of first scheduling sub-models, by inputting the historical running state information into each of the plurality of first scheduling sub-models.

The first training model 1040 is configured to, generate a second initial scheduling model by correcting the first initial scheduling model based on first matching degrees corresponding to each of the plurality of first scheduling sub-models; and return to generate the plurality of first scheduling sub-models based on the second initial scheduling model, until a difference between a second matching degree of the historical running state information and each of the candidate actions, determined by the second initial scheduling model, and a third matching degree of the historical running state information and each of the candidate actions, determined by the first initial scheduling model, is within a preset range, determine the second initial scheduling model as the power system scheduling model.

In a possible implementation of some embodiments of the disclosure, the historical state information includes running state information within a plurality of time periods, the second acquiring module 1030 is configured to: acquire a first matching degree of running state information within each of the plurality of time periods and each of the candidate actions by inputting the running state information within each of the plurality of time periods into the corresponding first scheduling sub-model. The first training module 1040 includes a first acquiring unit, a second acquiring unit, and a training unit.

The first acquiring unit is configured to acquire a third matching degree of the running state information within each of the plurality of time periods and each of the candidate actions by inputting the running state information within each of the plurality of time periods into the first initial scheduling model.

The second acquiring unit is configured to acquire a first reward value corresponding to the first initial scheduling model within each of the plurality of time periods based on third matching degrees corresponding to the first initial scheduling model within each of the plurality of time periods.

The second acquiring unit is further configured to, acquire a second reward value corresponding to the corresponding first scheduling sub-model within each of the plurality of time periods based on first matching degrees corresponding to the corresponding first scheduling sub-model within each of the plurality of time periods.

The training unit is configured to, generate the second initial scheduling model by correcting the first initial scheduling model based on first reward values and second reward values corresponding to the plurality of time periods.

In a possible implementation of some embodiments of the disclosure, the first acquiring unit is configured to: extract running state information at a plurality of moments from the running state information within each of the plurality of time periods; and acquire a third matching degree of running state information at each of the plurality of moments and each of the candidate actions by inputting the running state information at each of the plurality of moments into the first initial scheduling model.

The second acquiring unit, is further configured to: extract a first target action from the candidate actions based on third matching degrees; and determine the first reward value based on third matching degrees of the running state information at the plurality of moments and the first target action.

In a possible implementation of some embodiments of the disclosure, the second acquiring unit is further configured to: extract a plurality of reference actions from the candidate actions based on the third matching degrees; determine a first reference matching degree of the running state information at each of the plurality of moments and each of the plurality of reference actions based on a running state of a model by running the model corresponding to the power system based on each of the plurality of reference actions; and extract the first target action from the plurality of reference actions based on each of first reference matching degrees.

In a possible implementation of some embodiments of the disclosure, the apparatus may further include a first determining module, a third acquiring module, and a second training module.

The first determining module is configured to, determine a second reference matching degree of running state information at each of a plurality of moments and each of the candidate actions by running a model corresponding to the power system based on each of the candidate actions.

The third acquiring module is configured to acquire a fourth matching degree of the running state information at each of the plurality of moments and each of the candidate actions by inputting the running state information at each of the plurality of moments into an initial network model.

The second training module is configured to, correct the initial network model based on a difference between each of fourth matching degrees and the corresponding second reference matching degree, until a difference between the fourth matching degree of the running state information at each of the plurality of moments and each of the candidate actions determined based on the corrected initial network model, and the second reference matching degree, is within a preset range, determine the corrected initial network model as the first initial scheduling model.

In a possible implementation of some embodiments of the disclosure, the first determining module is configured to, determine a third reference matching degree of the running state information at each of the plurality of moments and each of actions by running of the model corresponding to the power system based on each of the actions.

The apparatus may further include a second determining module, a third determining module and a first extraction module.

The second determining module is configured to, determine actions having a highest third reference matching degree with the running state information at each of the plurality of moments based on each of third reference matching degrees.

The third determining module is configured to, determine a number of times of each of the actions having the highest third reference matching degree based on the actions having the highest third reference matching degree with the running state information at each of the plurality of moments.

The first extraction module is configured to, extract the candidate actions from the actions based on the number of times of each of the actions having the highest third reference matching degree.

In a possible implementation of some embodiments of the disclosure, the apparatus may further include a fourth acquiring module, a fifth acquiring module, a second extraction module, and a scheduling module.

The fourth acquiring module is configured to acquire current running state information of the power system.

The fifth acquiring module is configured to acquire a matching degree of the current running state information and each of the candidate actions by inputting the current running state information into the power system scheduling model.

The second extraction module is configured to, extract a second target action from the candidate actions based on the matching degree of the current running state information and each of the candidate actions.

The scheduling module is configured to, schedule the power system based on the second target action.

It should be noted that the foregoing explanation of the embodiments of the method for training the power system scheduling model are also applied to the apparatus for training the power system scheduling model in the embodiments, which will not be repeated herein.

According to some embodiments of the disclosure, the plurality of first scheduling sub-models with the same network structure as the first initial scheduling model are generated based on the first initial scheduling model, the historical running state information is input into each of the plurality of first scheduling sub-models to acquire the first matching degree of the historical running state information and each of candidate actions, the first initial scheduling model is corrected to generate the second initial scheduling model based on the first matching degrees respectively corresponding to the plurality of first scheduling sub-models, and it returns to execute the operation of generating the plurality of first scheduling sub-models based on the second initial scheduling model, until the matching degree output by the second initial scheduling module meets the convergence condition, so as to acquire the power system scheduling module. Thus, large-scale evolutionary learning is performed on the first initial scheduling model, to acquire the power system scheduling model, and the power system scheduling model is employed to schedule the power system, thereby enhancing a degree of automation of scheduling the power system.

According to some embodiments of the disclosure, a computer device, a readable storage medium and a computer program product are further provided.

FIG. 11 is a block diagram illustrating an example computer device 1100 according to some embodiments of the disclosure. Computer devices are intended to represent various types of digital computers, such as laptop computers, desktop computers, workstations, personal digital assistants, servers, blade servers, mainframe computers, and other suitable computers. Computer devices are may also represent various types of mobile apparatuses, such as personal digital assistants, cellular phones, smart phones, wearable devices, and other similar computing devices. The components shown herein, their connections and relations, and their functions are merely examples, and are not intended to limit the implementation of the disclosure described and/or required herein.

As illustrated in FIG. 11, the device 1100 includes a computing unit 1101 configured to execute various appropriate actions and processings according to the computer program stored in a read-only memory (ROM) 1102 or loaded from a memory unit 1108 to a random access memory (RAM) 1103. In a RAM 1103, various programs and data required for a device 1100 may be stored. A computing unit 1101, a ROM 1102 and a ROM 1103 may be connected with each other by a bus 1104. An input/output (I/O) interface 1105 is also connected to a bus 1104.

A plurality of components in the device 1100 are connected to an I/O interface 1105, and includes: an input unit 1106, for example, a keyboard, a mouse, etc.; an output unit 1107, for example various types of displays, speakers; a memory unit 1108, for example a magnetic disk, an optical disk; and a communication unit 1109, for example, a network card, a modem, a wireless transceiver. A communication unit 1109 allows a device 1100 to exchange information/data through a computer network such as internet and/or various types of telecommunication networks and other devices.

The computing unit 1101 may be various types of general and/or dedicated processing components with processing and computing ability. Some examples of a computing unit 1101 include but not limited to a central processing unit (CPU), a graphic processing unit (GPU), various dedicated artificial intelligence (AI) computing chips, various computing units running a machine learning model algorithm, a digital signal processor (DSP), and any appropriate processor, controller, microcontroller, etc. A computing unit 1101 performs various methods and processings as described above, for example, a method for training a power system scheduling model. For example, in some embodiments, a method for training a power system scheduling model may be further implemented as a computer software program, which is physically contained in a machine readable medium, such as a memory unit 1108. In some embodiments, a part or all of the computer program may be loaded and/or installed on the device 1100 through a ROM 1102 and/or a communication unit 1109. When the computer program is loaded on a RAM 1103 and executed by a computing unit 1101, one or more blocks in the method for training a power system scheduling model as described above may be performed. Alternatively, in other embodiments, a computing unit 1101 may be configured to perform a method for training a power system scheduling model in other appropriate methods (for example, by virtue of a firmware).

Various implementation modes of systems and technologies described herein may be implemented in a digital electronic circuit system, an integrated circuit system, a field programmable gate array (FPGA), a dedicated application specific integrated circuit (ASIC), an application specific standard product (ASSP), a system on a chip (SoC), a complex programmable logic device (CPLD), a computer hardware, a firmware, a software, and/or combinations thereof. The various implementation modes may include: being implemented in one or more computer programs, and the one or more computer programs may be executed and/or interpreted on a programmable system including at least one programmable processor, and the programmable processor may be a dedicated or a general-purpose programmable processor that may receive data and instructions from a storage system, at least one input apparatus, and at least one output apparatus, and transmit the data and instructions to the storage system, the at least one input apparatus, and the at least one output apparatus.

A computer code configured to execute a method in the disclosure may be written with one or any combination of multiple programming languages. These programming languages may be provided to a processor or a controller of a general purpose computer, a dedicated computer, or other apparatuses for programmable data processing so that the function/operation specified in the flowchart and/or block diagram may be performed when the program code is executed by the processor or controller. A computer code may be executed completely or partly on the machine, executed partly on the machine as an independent software package and executed partly or completely on the remote machine or server.

In the context of the disclosure, a machine-readable medium may be a tangible medium that may contain or store a program intended for use in or in conjunction with an instruction execution system, apparatus, or device. A machine-readable medium may be a machine readable signal medium or a machine readable storage medium. A machine readable storage medium may include but not limited to an electronic, magnetic, optical, electromagnetic, infrared, or semiconductor system, apparatus or device, or any appropriate combination thereof. A more specific example of a machine readable storage medium includes an electronic connector with one or more cables, a portable computer disk, a hardware, a RAM, a ROM, an EPROM or a flash memory, an optical fiber device, and a compact disc read-only memory(CD-ROM), an optical storage device, a magnetic storage device, or any appropriate combination thereof.

In order to provide interaction with the user, the systems and technologies described here may be implemented on a computer, and the computer has: a display apparatus for displaying information to the user (for example, a CRT (cathode ray tube) or a LCD (liquid crystal display) monitor); and a keyboard and a pointing apparatus (for example, a mouse or a trackball) through which the user may provide input to the computer. Other types of apparatuses may be further configured to provide interaction with the user; for example, the feedback provided to the user may be any form of sensory feedback (for example, visual feedback, auditory feedback, or tactile feedback); and input from the user may be received in any form (including an acoustic input, a voice input, or a tactile input).

The systems and technologies described herein may be implemented in a computing system including back-end components (for example, as a data server), or a computing system including middleware components (for example, an application server), or a computing system including front-end components (for example, a user computer with a graphical user interface or a web browser through which the user may interact with the implementation mode of the system and technology described herein), or a computing system including any combination of such back-end components, middleware components or front-end components. The system components may be connected to each other through any form or medium of digital data communication (for example, a communication network). The examples of a communication network include a Local Area Network (LAN), a Wide Area Network (WAN), an internet and a blockchain network.

The computer system may include a client and a server. The client and server are generally far away from each other and generally interact with each other through a communication network. The relation between the client and the server is generated by computer programs that run on the corresponding computer and have a client-server relationship with each other. A server may be a cloud server, also known as a cloud computing server or a cloud host, is a host product in a cloud computing service system, to solve the shortcomings of large management difficulty and weak business expansibility existed in the traditional physical host and Virtual Private Server (VPS) service. A server further may be a server with a distributed system, or a server in combination with a blockchain.

According to some embodiments of the disclosure, a computer program product is further provided. The instructions in the computer program product are configured to perform a method for training a power system scheduling model as described when performed by a processor.

It should be understood that, various forms of procedures shown above may be configured to reorder, add or delete blocks. For example, blocks described in the disclosure may be executed in parallel, sequentially, or in a different order, as long as the desired result of the technical solution disclosed in the disclosure may be achieved, which will not be limited herein.

The above specific implementations do not constitute a limitation on the protection scope of the disclosure. Those skilled in the art should understand that various modifications, combinations, sub-combinations and substitutions may be made according to design requirements and other factors. Any modification, equivalent replacement, improvement, etc., made within the spirit and principle of embodiments of the disclosure shall be included within the protection scope of embodiments of the disclosure.

What is claimed is:

1. A method for training a power system scheduling model, performed by a computer device, comprising:
acquiring a training data set and a first initial scheduling model, wherein, the training data set comprises historical running state information of a power system;
generating a plurality of first scheduling sub-models based on the first initial scheduling model, wherein, a network structure of each of the plurality of first scheduling sub-models is the same as a network structure of the first initial scheduling model;
acquiring a first matching degree of the historical running state information and each of candidate actions, output by each of the plurality of first scheduling sub-models, by inputting the historical running state information into each of the plurality of first scheduling sub-models;
generating a second initial scheduling model by correcting the first initial scheduling model based on first matching degrees corresponding to each of the plurality of first scheduling sub-models; and
returning to generating the plurality of first scheduling sub-models based on the second initial scheduling model, until a difference between a second matching degree of the historical running state information and each of the candidate actions, determined by the second initial scheduling model, and a third matching degree of the historical running state information and each of the candidate actions, determined by the first initial scheduling model, is within a preset range, determining the second initial scheduling model as the power system scheduling model.

2. The method of claim 1, wherein, the historical running state information comprises running state information within a plurality of time periods,
wherein, acquiring a first matching degree of the historical running state information and each of candidate actions, output by each of the plurality of first scheduling sub-models, comprises:
acquiring a first matching degree of running state information within each of the plurality of time periods and each of the candidate actions by inputting the running state information within each of the plurality of time periods into the corresponding first scheduling sub-model;
wherein, generating a second initial scheduling model by correcting the first initial scheduling model based on first matching degrees corresponding to each of the plurality of first scheduling sub-models, comprises:
acquiring a third matching degree of the running state information within each of the plurality of time periods and each of the candidate actions by inputting the running state information within each of the plurality of time periods into the first initial scheduling model;
acquiring a first reward value corresponding to the first initial scheduling model within each of the plurality of time periods based on third matching degrees corresponding to the first initial scheduling model within each of the plurality of time periods;
acquiring a second reward value corresponding to the corresponding first scheduling sub-model within each of the plurality of time periods based on first matching degrees corresponding to the corresponding first scheduling sub-model within each of the plurality of time periods; and
generating the second initial scheduling model by correcting the first initial scheduling model based on first reward values and second reward values corresponding to the plurality of time periods.

3. The method of claim 2,
wherein, acquiring a third matching degree of the running state information within each of the plurality of time periods and each of the candidate actions by inputting the running state information within each of the plurality of time periods into the first initial scheduling model, comprises:
extracting running state information at a plurality of moments from the running state information within each of the plurality of time periods; and
acquiring a third matching degree of running state information at each of the plurality of moments and each of the candidate actions by inputting the running state information at each of the plurality of moments into the first initial scheduling model;
wherein, acquiring a first reward value corresponding to the first initial scheduling model within each of the plurality of time periods based on third matching degrees corresponding to the first initial scheduling model within each of the plurality of time periods, comprises:
extracting a first target action from the candidate actions based on third matching degrees; and
determining the first reward value based on third matching degrees of the running state information at the plurality of moments and the first target action.

4. The method of claim 3, wherein, extracting a first target action from the candidate actions based on third matching degrees, comprises:
extracting a plurality of reference actions from the candidate actions based on the third matching degrees;
determining a first reference matching degree of the running state information at each of the plurality of moments and each of the plurality of reference actions based on a running state of a model by running the model corresponding to the power system based on each of the plurality of reference actions; and
extracting the first target action from the plurality of reference actions based on each of first reference matching degrees.

5. The method of claim 1, further comprising:
determining a second reference matching degree of running state information at each of a plurality of moments and each of the candidate actions by running a model corresponding to the power system based on each of the candidate actions;
acquiring a fourth matching degree of the running state information at each of the plurality of moments and each of the candidate actions by inputting the running state information at each of the plurality of moments into an initial network model; and
correcting the initial network model based on a difference between each of fourth matching degrees and the corresponding second reference matching degree, until a difference between the fourth matching degree of the running state information at each of the plurality of moments and each of the candidate actions determined based on the corrected initial network model, and the second reference matching degree, is within a preset range, determining the corrected initial network model as the first initial scheduling model.

6. The method of claim 5, further comprising:
determining a third reference matching degree of the running state information at each of the plurality of moments and each of actions by running of the model corresponding to the power system based on each of the actions;
determining actions having a highest third reference matching degree with the running state information at each of the plurality of moments based on each of third reference matching degrees;
determining a number of times of each of the actions having the highest third reference matching degree based on the actions having the highest third reference matching degree with the running state information at each of the plurality of moments; and
extracting the candidate actions from the actions based on the number of times of each of the actions having the highest third reference matching degree.

7. The method of claim 1, further comprising:
acquiring current running state information of the power system;
acquiring a matching degree of the current running state information and each of the candidate actions by inputting the current running state information into the power system scheduling model;
extracting a second target action from the candidate actions based on the matching degree of the current running state information and each of the candidate actions; and
scheduling the power system based on the second target action.

8. A computer device, comprising:
at least one processor; and
a memory communicatively connected to the at least one processor; wherein,
the memory is configured to store instructions executable by the at least one processor, and when the instructions are performed by the at least one processor, the at least one processor is caused to perform:
acquiring a training data set and a first initial scheduling model, wherein, the training data set comprises historical running state information of a power system;
generating a plurality of first scheduling sub-models based on the first initial scheduling model, wherein, a network structure of each of the plurality of first scheduling sub-models is the same as a network structure of the first initial scheduling model;
acquiring a first matching degree of the historical running state information and each of candidate actions, output by each of the plurality of first scheduling sub-models, by inputting the historical running state information into each of the plurality of first scheduling sub-models;
generating a second initial scheduling model by correcting the first initial scheduling model based on first matching degrees corresponding to each of the plurality of first scheduling sub-models; and
returning to generating the plurality of first scheduling sub-models based on the second initial scheduling model, until a difference between a second matching degree of the historical running state information and each of the candidate actions, determined by the second initial scheduling model, and a third matching degree of the historical running state information and each of the candidate actions, determined by the first initial scheduling model, is within a preset range, determining the second initial scheduling model as the power system scheduling model.

9. The computer device of claim 8, wherein, the historical running state information comprises running state information within a plurality of time periods,
wherein, when the instructions are performed by the at least one processor, the at least one processor is caused to perform:
acquiring a first matching degree of running state information within each of the plurality of time periods and each of the candidate actions by inputting the running state information within each of the plurality of time periods into the corresponding first scheduling sub-model;
acquiring a third matching degree of the running state information within each of the plurality of time periods and each of the candidate actions by inputting the running state information within each of the plurality of time periods into the first initial scheduling model;
acquiring a first reward value corresponding to the first initial scheduling model within each of the plurality of time periods based on third matching degrees corresponding to the first initial scheduling model within each of the plurality of time periods;
acquiring a second reward value corresponding to the corresponding first scheduling sub-model within each of the plurality of time periods based on first matching degrees corresponding to the corresponding first scheduling sub-model within each of the plurality of time periods; and
generating the second initial scheduling model by correcting the first initial scheduling model based on first reward values and second reward values corresponding to the plurality of time periods.

10. The computer device of claim 9, wherein, when the instructions are performed by the at least one processor, the at least one processor is caused to perform:
extracting running state information at a plurality of moments from the running state information within each of the plurality of time periods; and
acquiring a third matching degree of running state information at each of the plurality of moments and each of the candidate actions by inputting the running state information at each of the plurality of moments into the first initial scheduling model;
extracting a first target action from the candidate actions based on third matching degrees; and
determining the first reward value based on third matching degrees of the running state information at the plurality of moments and the first target action.

11. The computer device of claim 10, wherein, when the instructions are performed by the at least one processor, the at least one processor is caused to perform:
extracting a plurality of reference actions from the candidate actions based on the third matching degrees;
determining a first reference matching degree of the running state information at each of the plurality of moments and each of the plurality of reference actions based on a running state of a model by running the model corresponding to the power system based on each of the plurality of reference actions; and
extracting the first target action from the plurality of reference actions based on each of first reference matching degrees.

12. The computer device of claim 8, wherein, when the instructions are performed by the at least one processor, the at least one processor is caused to perform:
determining a second reference matching degree of running state information at each of a plurality of moments and each of the candidate actions by running a model corresponding to the power system based on each of the candidate actions;
acquiring a fourth matching degree of the running state information at each of the plurality of moments and each of the candidate actions by inputting the running state information at each of the plurality of moments into an initial network model; and
correcting the initial network model based on a difference between each of fourth matching degrees and the corresponding second reference matching degree, until a difference between the fourth matching degree of the running state information at each of the plurality of moments and each of the candidate actions determined based on the corrected initial network model, and the second reference matching degree, is within a preset range, determining the corrected initial network model as the first initial scheduling model.

13. The computer device of claim 12, wherein, when the instructions are performed by the at least one processor, the at least one processor is caused to perform:
determining a third reference matching degree of the running state information at each of the plurality of moments and each of actions by running of the model corresponding to the power system based on each of the actions;
determining actions having a highest third reference matching degree with the running state information at each of the plurality of moments based on each of third reference matching degrees;
determining a number of times of each of the actions having the highest third reference matching degree based on the actions having the highest third reference matching degree with the running state information at each of the plurality of moments; and
extracting the candidate actions from the actions based on the number of times of each of the actions having the highest third reference matching degree.

14. The computer device of claim 8, wherein, when the instructions are performed by the at least one processor, the at least one processor is caused to perform:
acquiring current running state information of the power system;
acquiring a matching degree of the current running state information and each of the candidate actions by inputting the current running state information into the power system scheduling model;
extracting a second target action from the candidate actions based on the matching degree of the current running state information and each of the candidate actions; and
scheduling the power system based on the second target action.

15. A non-transitory computer-readable storage medium stored with computer instructions, wherein, the computer instructions are configured to cause a computer to perform a method for training a power system scheduling model, the method comprising:
acquiring a training data set and a first initial scheduling model, wherein, the training data set comprises historical running state information of a power system;
generating a plurality of first scheduling sub-models based on the first initial scheduling model, wherein, a network structure of each of the plurality of first scheduling sub-models is the same as a network structure of the first initial scheduling model;
acquiring a first matching degree of the historical running state information and each of candidate actions, output by each of the plurality of first scheduling sub-models, by inputting the historical running state information into each of the plurality of first scheduling sub-models;
generating a second initial scheduling model by correcting the first initial scheduling model based on first matching degrees corresponding to each of the plurality of first scheduling sub-models; and
returning to generating the plurality of first scheduling sub-models based on the second initial scheduling model, until a difference between a second matching degree of the historical running state information and each of the candidate actions, determined by the second initial scheduling model, and a third matching degree of the historical running state information and each of the candidate actions, determined by the first initial scheduling model, is within a preset range, determining the second initial scheduling model as the power system scheduling model.

16. The non-transitory computer-readable storage medium of claim 15, wherein, the historical running state information comprises running state information within a plurality of time periods,
wherein, acquiring a first matching degree of the historical running state information and each of candidate actions, output by each of the plurality of first scheduling sub-models, comprises:
acquiring a first matching degree of running state information within each of the plurality of time periods and each of the candidate actions by inputting the running state information within each of the plurality of time periods into the corresponding first scheduling sub-model;
wherein, generating a second initial scheduling model by correcting the first initial scheduling model based on first matching degrees corresponding to each of the plurality of first scheduling sub-models, comprises:
acquiring a third matching degree of the running state information within each of the plurality of time periods and each of the candidate actions by inputting the running state information within each of the plurality of time periods into the first initial scheduling model;
acquiring a first reward value corresponding to the first initial scheduling model within each of the plurality of time periods based on third matching degrees corresponding to the first initial scheduling model within each of the plurality of time periods;
acquiring a second reward value corresponding to the corresponding first scheduling sub-model within each of the plurality of time periods based on first matching degrees corresponding to the corresponding first scheduling sub-model within each of the plurality of time periods; and
generating the second initial scheduling model by correcting the first initial scheduling model based on first reward values and second reward values corresponding to the plurality of time periods.

17. The non-transitory computer-readable storage medium of claim 16,
wherein, acquiring a third matching degree of the running state information within each of the plurality of time periods and each of the candidate actions by inputting the running state information within each of the plurality of time periods into the first initial scheduling model, comprises:
extracting running state information at a plurality of moments from the running state information within each of the plurality of time periods; and
acquiring a third matching degree of running state information at each of the plurality of moments and each of the candidate actions by inputting the running state information at each of the plurality of moments into the first initial scheduling model;
wherein, acquiring a first reward value corresponding to the first initial scheduling model within each of the plurality of time periods based on third matching degrees corresponding to the first initial scheduling model within each of the plurality of time periods, comprises:
extracting a first target action from the candidate actions based on third matching degrees; and
determining the first reward value based on third matching degrees of the running state information at the plurality of moments and the first target action.

18. The non-transitory computer-readable storage medium of claim 17, wherein, extracting a first target action from the candidate actions based on third matching degrees, comprises:
extracting a plurality of reference actions from the candidate actions based on the third matching degrees;
determining a first reference matching degree of the running state information at each of the plurality of moments and each of the plurality of reference actions based on a running state of a model by running the model corresponding to the power system based on each of the plurality of reference actions; and
extracting the first target action from the plurality of reference actions based on each of first reference matching degrees.

19. The non-transitory computer-readable storage medium of claim 15, wherein the method further comprises:
determining a second reference matching degree of running state information at each of a plurality of moments and each of the candidate actions by running a model corresponding to the power system based on each of the candidate actions;
acquiring a fourth matching degree of the running state information at each of the plurality of moments and each of the candidate actions by inputting the running state information at each of the plurality of moments into an initial network model; and
correcting the initial network model based on a difference between each of fourth matching degrees and the corresponding second reference matching degree, until a difference between the fourth matching degree of the running state information at each of the plurality of moments and each of the candidate actions determined based on the corrected initial network model, and the second reference matching degree, is within a preset range, determining the corrected initial network model as the first initial scheduling model.

20. The non-transitory computer-readable storage medium of claim 19, wherein the method further comprises:
determining a third reference matching degree of the running state information at each of the plurality of moments and each of actions by running of the model corresponding to the power system based on each of the actions;
determining actions having a highest third reference matching degree with the running state information at each of the plurality of moments based on each of third reference matching degrees;
determining a number of times of each of the actions having the highest third reference matching degree based on the actions having the highest third reference matching degree with the running state information at each of the plurality of moments; and
extracting the candidate actions from the actions based on the number of times of each of the actions having the highest third reference matching degree.
